(19) United States
(12) Patent Application Publication
(10) Pub. No.: US 2003/0142360 A1
(43) Pub. Date: Jul. 31, 2003

(54) Method and system for identifying a scanned image

(76) Inventors: Bruce L. Johnson, Eagle, ID (US); Bradley J. Anderson, Boise, ID (US)

Correspondence Address: HEWLETT-PAKCARD COMPANY, Intellectual Property Adminstration, P.O. Box 272400, Fort Collins, CO, 80527-2400, US

(21) Appl. No.: 10/062,637

(22) Filed: Jan. 31, 2002

(51) Int. Cl. H04N 1/405; G06K 15/00; H04K 1/00; H04N 1/44

(52) U.S. Cl. 358/3.28; 358/3.07; 358/1.2

(57) ABSTRACT

A method of identifying a scanned image includes creating an original image with a plurality of halftone resolutions. The original image is then scanned at a scanning resolution to create the scanned image. When the scanning resolution is related to at least one of the plurality of halftone resolutions of the original image, a stamp is generated in the scanned image.

### THE FIELD OF THE INVENTION

The present invention generally relates to image processing, and in particular to identifying a scanned image when an original image is reproduced by optical scanning.

### BACKGROUND OF THE INVENTION

Due to the widespread availability of high-quality, low-priced color photocopiers and desk-top publishing systems, counterfeiting of documents, such as banknotes, is becoming, now more than ever, a serious problem. Various methods have been introduced for counterfeit prevention and authentication of documents. These methods include the use of special paper, special inks, watermarks, micro-letters, security threads, holograms, etc. Such methods, however, considerably increase the cost of producing the original image.

Accordingly, a need exists for identifying and distinguishing a scanned image from an original image without considerably increasing the cost of the original image.

### SUMMARY OF THE INVENTION

One aspect of the present invention provides a method of identifying a scanned image. The method includes creating an original image with a plurality of halftone resolutions. The original image is then scanned at a scanning resolution to create the scanned image. When the scanning resolution is related to at least one of the plurality of halftone resolutions of the original image, a stamp is generated in the scanned image.

### BRIEF DESCRIPTION OF THE DRAWINGS

FIG. 1 is a schematic illustration of one embodiment of an image identification system according to the present invention.

FIG. 2 is a schematic illustration of one embodiment of a portion of an original image including a plurality of halftone resolutions varied vertically according to the present invention.

FIG. 3 is a schematic illustration of one embodiment of a portion of an original image including a plurality of halftone resolutions varied horizontally according to the present invention.

FIG. 4 is a schematic illustration of one embodiment of an image identification system according to the present invention.

FIG. 5 is a flow diagram illustrating one embodiment of a method of identifying a scanned image according to the present invention.

FIG. 6 is a flow diagram illustrating one embodiment of a method of creating a halftone image according to the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

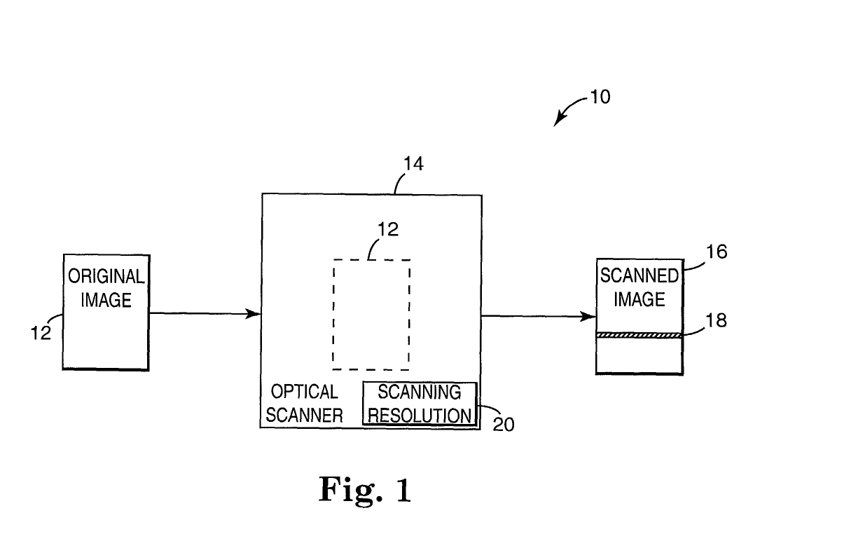

FIG. 1 illustrates one embodiment of a portion of an image identification system 10 according to the present invention. Image identification system 10 includes an original image 12, an optical scanner 14, and a scanned image 16 with a stamp 18. Image identification system 10 facilitates identification or distinguishment of scanned image 16 from original image 12 when original image 12 is scanned by optical scanner 14 at a scanning resolution 20. When original image 12 is scanned at scanning resolution 20, image identification system 10 generates stamp 18 on scanned image 16. Stamp 18 identifies scanned image 16 as a reproduction of original image 12. As such, presence of stamp 18 may identify scanned image 16 as a counterfeit of original image 12. Stamp 18 includes, for example, a word, symbol, character, mark, design, seal, pattern, distortion of the original image, and/or image artifact in scanned image 16.

In one exemplary embodiment, original image 12 includes a halftone image produced by a halftoning process. Halftoning, as is well known in the art, uses patterns of individual dots to create various colors or grays with a device, such as a printer or a display. For example, with halftoning, colors other than cyan, yellow, magenta, black, red, green, and/or blue, including varying shades or levels of such colors, can be created with a device. As such, the halftone image includes a plurality of image dots with an intensity or darkness density of the image dots being varied to produce an image. The halftone image has a halftone resolution and at least one halftone angle. As such, spacing of the rows establishes the halftone resolution of the halftone image. The halftone resolution is typically represented in resolutions of 100×halftones-per-inch (hpi) such as 200 hpi, 400 hpi, 600 hpi, etc.

Optical scanner 14 may be or may be included in a wide variety of devices such as a printer, multi-functional peripheral (MFP), fax machine, copier, hard copy imaging device, communication and telephony device. Typically, optical scanners employ physical or scanning resolutions of 100×dpi, such as 200 dpi, 300 dpi, 600 dpi, etc. As such, scanning resolution 20 of optical scanner 14 has a mathematical relationship to the halftone resolution of original image 12. When scanning resolution 20 of optical scanner 14 is mathematically related to the halftone resolution of original image 12 by a simple mathematical formula (e.g., 100×), optical scanner 14 picks up alternating light parts and dark parts of original image 12 to generate stamp 18 on scanned image 16. The generation of stamp 18 on scanned image 16 by optical scanner 14 when original image 12 is scanned, distinguishes scanned image 16 from original image 12.

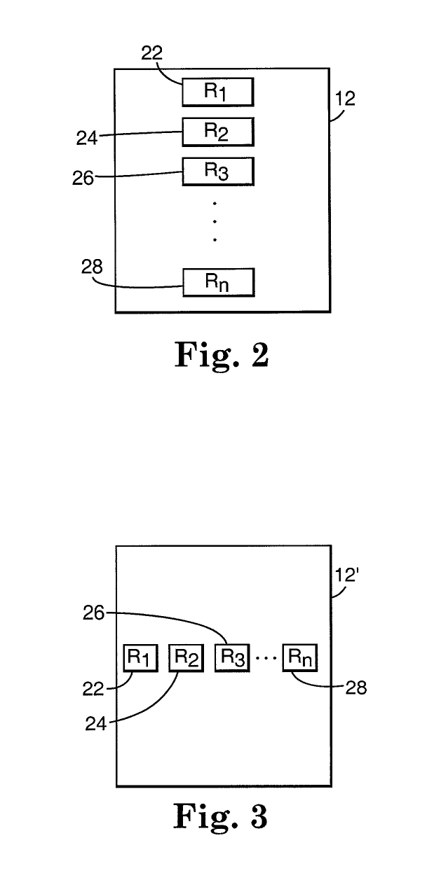

FIG. 2 schematically illustrates one exemplary embodiment of a portion of original image 12. Original image 12 includes a plurality of halftone resolutions, R₁, R₂, R₃, . . . R_{n,} identified as 22, 24, 26 and 28. Halftone resolutions 22, 24, 26 and 28 represent different image portions of halftone images 12 and 12′ and are used to create original image 12 and interact with scanning resolution 20 of optical scanner 14 to generate stamp 18 on scanned image 16. Preferably, scanning resolution 20 of optical scanner 14 is related to at least one of the halftone resolutions 22, 24, 26 and 28 of original image 12. More specifically, scanning resolution 20 matches at least one of the halftone resolutions 22, 24, 26 and 28 used to create original image 12. As such, as original image 12 is scanned by optical scanner 14, optical scanner 14 picks up alternating light and dark parts of original image 12 to generate stamp 18 in scanned image 16 where scanning resolution 20 of optical scanner 14 is related to or matches at least one of the halftone resolutions 22, 24, 26 and 28 of original image 12.

In one embodiment, halftone resolutions 22, 24, 26 and 28 of original image 12 are varied vertically from approximately 75 hpi to approximately 600 hpi throughout original image 12 to create original image 12. In another embodiment, halftone resolutions 22, 24, 26 and 28 are scaled vertically from approximately 75 hpi to approximately 600 hpi to create original image 12. Varying and/or scaling of the halftone resolutions 22, 24, 26 and 28 may be either from top to bottom or from bottom to top of original image 12.

FIG. 3 is a schematic illustration of another exemplary embodiment of a portion of another embodiment of original image 12. In one embodiment, halftone resolutions 22, 24, 26 and 28 are varied horizontally from approximately 75 hpi to approximately 600 hpi throughout original image 12′ as original image 12′ is created. In another embodiment, halftone resolutions 22, 24, 26 and 28 are scaled horizontally from approximately 75 hpi to approximately 600 hpi to create original image 12′. Halftone resolutions 22, 24, 26 and 28 may be varied and/or scaled from either left to right or right to left in original image 12′.

Varying halftone resolutions 22, 24, 26 and 28 throughout original image 12 in FIG. 2 and original image 12′ in FIG. 3 ensures that scanning resolution 20 will be related to or match at least one of the halftone resolutions 22, 24, 26 and 28 of original image 12 or 12′. As such, stamp 18 will be generated on scanned image 16 when original image 12 or 12′ is scanned by optical scanner 14. Accordingly, regardless of scanning resolution 20 of optical scanner 14 used to scan original image 12 or 12′, optical scanner 14 will generate stamp 18 somewhere on scanned image 16. More specifically, optical scanner 14 will generate stamp 18 where scanning resolution 20 is related to or matches at least one of the halftone resolutions 22, 24, 26 and 28. For example, if scanning resolution 20 of optical scanner 14 is 200 dpi and original image 12 contains an image portion created with halftone resolution 22, which is 200 hpi, stamp 18 will be generated in scanned image 16 where original image 12 was created with halftone resolution 22 since scanning resolution 20 matches halftone resolution 22. Stamp 18 will also be generated on scanned image 16 where the image portion is created with at least one of the halftone resolutions related to scanning resolution 20 by 100×, e.g., 100 hpi, 400 hpi, 600 hpi, etc. Generation of stamp 18 in scanned image 16, therefore, clearly distinguishes scanned image 16 from original image 12 or 12′.

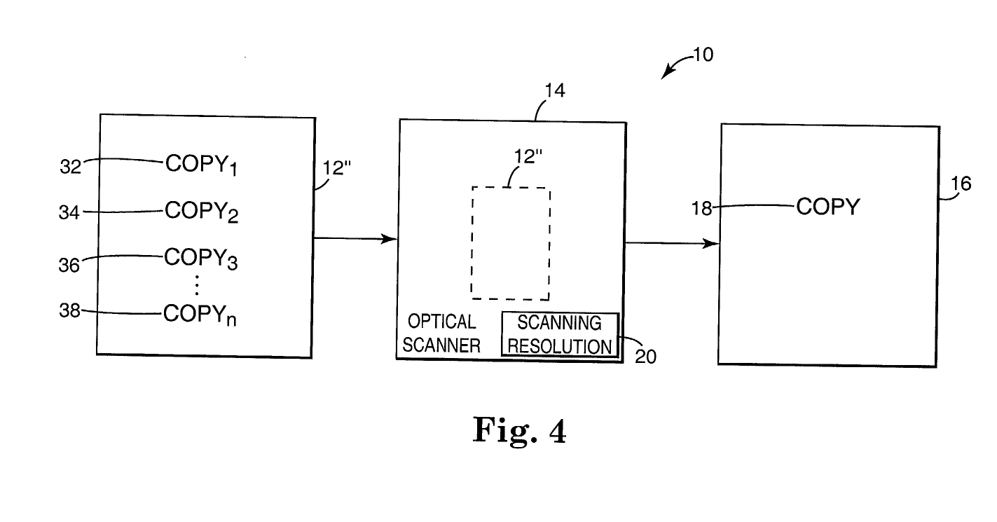

FIG. 4 is a schematic illustration of another exemplary embodiment of a portion of another embodiment of original image 12. In FIG. 4, halftone resolutions 22, 24, 26 and 28 are varied both vertically and horizontally throughout original image 12″ to create original image 12″ such that when optical scanner 14 scans original image 12″, stamp 18, which spells out the word “COPY,” will be generated on scanned image 16 when scanning resolution 20 is related to or matches at least one of the halftone resolutions 22, 24, 26 and 28 as illustrated in FIGS. 2 and 3. Stamp 18 is not visible to a naked eye in original image 12″ (or original images 12 or 12′). However, when scanning resolution 20 of optical scanner 14 is related to at least one of the halftone resolutions 22, 24, 26 and 28 of original image 12″0 (or original images 12 or 12′), stamp 18 is made visible in scanned image 16. For example, COPY₁ 32, COPY₂ 34, COPY₃ 36, . . . COPYₙ 38 will be embedded in original image 12″ by varying the halftone resolutions 22, 24, 26 and 28 both vertically and horizontally to create original image 12″. When optical scanner 14 scans original image 12″, and, for example, scanning resolution 20 of optical scanner 14 is related to or matches halftone resolution 22 used to embed COPY₁ 32 in original image 12″, the word “COPY” is generated on scanned image 16. In another embodiment, stamp 18 is repeated throughout scanned image 16. Again, varying halftone resolutions 22, 23, 26 and 28 throughout original image 12″ when original image 12″ is created ensures that, regardless of scanning resolution 20 employed by optical scanner 14, scanned image 16 will be clearly distinguishable from original image 12″ by stamp 18.

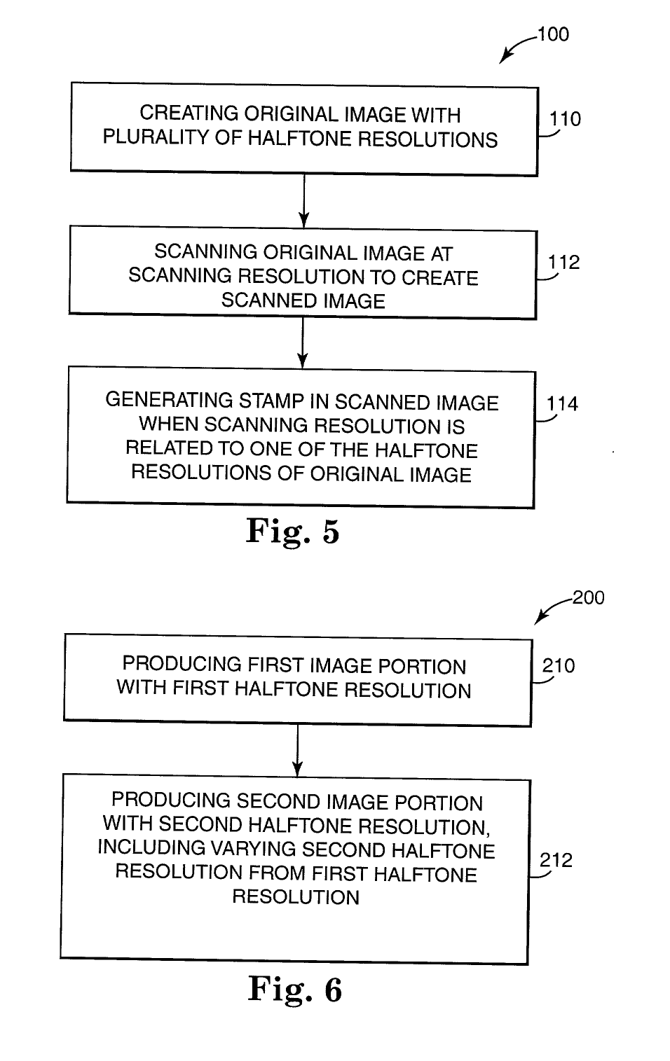

In FIG. 5, a flow diagram illustrating one exemplary embodiment of a method of identifying scanned image 16 according to the present invention is illustrated generally at 100. Reference is also made to FIGS. 1-4. At 110, original image 12 or 12′ is created with halftone resolutions, R₁ 22, R₂ 24, R₃ 26, . . . Rₙ 28, as illustrated, for example, in FIGS. 2 and 3. At 112, original image 12 or 12′ is scanned by optical scanner 14 with scanning resolution 20 to create scanned image 16. At 114, as optical scanner 14 scans original image 12, optical scanner 14 generates stamp 18 in scanned image 16 when scanning resolution 20 of optical scanner 14 is related to at least one of the halftone resolutions, R₁ 22, R₂ 24, R₃ 26, . . . Rₙ 28 of original image 12 or 12′.

In FIG. 6, a flow diagram illustrating one exemplary embodiment of a method of creating original image 12 (including original image 12′ and 12″) as a halftone image according to the present invention is illustrated generally at 200. Reference is also made to FIGS. 1-4. At 210, a first image portion, for example, R₁ 22 of original image 12 is produced with a first halftone resolution, for example, R₁ 22. At 212, a second image portion, for example, R₂ 24 of original image 12 is produced with a second halftone resolution, for example, R₂. As such, the second resolution of the second image portion is varied from the first halftone resolution of the first image portion. In one embodiment, steps 210 and 212 of method 200 are performed via computer-executable instructions of a computer-readable medium. Computer-readable medium, as used herein, is defined to include any kind of computer memory such as a floppy disk, conventional hard disk, CD-ROM, Flash ROM, non-volatile ROM, RAM, etc.

Thus, by taking advantage of existing properties of halftone images and optical scanners, identification system 10 identifies and distinguishes scanned image 16 from original image 12. As such, identification system 10 does so without considerably increasing the cost of original image 12.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of identifying a scanned image, the method comprising:
creating an original image with a plurality of halftone resolutions;
scanning the original image at a scanning resolution to create the scanned image; and
generating a stamp in the scanned image when the scanning resolution is related to at least one of the plurality of halftone resolutions of the original image.

2. The method of claim 1, wherein creating the original image includes scaling the plurality of halftone resolutions of the original image throughout the original image.

3. The method of claim 1, wherein creating the original image includes varying the plurality of halftone resolutions of the original image from approximately 75 halftones-per-inch to approximately 600 halftones-per-inch throughout the original image.

4. The method of claim 1, wherein the scanning resolution is related to the at least one of the plurality of halftone resolutions of the original image when the scanning resolution matches the at least one of the plurality of halftone resolutions of the original image.

5. The method of claim 1, wherein generating the stamp in the scanned image includes distinguishing the scanned image from the original image.

6. The method of claim 1, wherein generating the stamp in the scanned image includes making the stamp visible in the scanned image.

7. The method of claim 1, wherein generating the stamp in the scanned image includes generating at least one of a word, symbol, character, mark, design, seal, pattern, distortion of the original image, and image artifact in the scanned image.

8. A system for identifying a scanned image, the system comprising:
an original image having a plurality of halftone resolutions; and
an optical scanner having a scanning resolution that is related to at least one of the plurality of halftone resolutions of the original image,
wherein the optical scanner is adapted to scan the original image and generate a stamp in the scanned image when the scanning resolution of the optical scanner is related to the at least one of the plurality of halftone resolutions of the original image.

9. The system of claim 8, wherein the plurality of halftone resolutions of the original image are scaled throughout the original image.

10. The system of claim 8, wherein the plurality of halftone resolutions of the original image are varied from approximately 75 halftones-per-inch to approximately 600 halftones-per-inch throughout the original image.

11. The system of claim 8, wherein the scanning resolution of the optical scanner is related to the at least one of the plurality of halftone resolutions of the original image when the scanning resolution of the optical scanner matches at least one of the plurality of halftone resolutions of the original image.

12. The system of claim 8, wherein the stamp distinguishes the scanned image from the original image.

13. The system of claim 8, wherein the stamp is made visible in the scanned image when the scanning resolution of the optical scanner is related to the at least one of the plurality of halftone resolutions of the original image.

14. The system of claim 8, wherein the stamp includes at least one of a word, symbol, character, mark, design, seal, pattern, distortion of the original image, and image artifact in the scanned image.

15. A method of creating a halftone image, the method comprising:
producing a first image portion of the halftone image with a first halftone resolution; and
producing at least a second image portion of the halftone image with at least a second halftone resolution, including varying the at least second halftone resolution of the at least second image portion from the first halftone resolution of the first image portion.

16. The method of claim 15, wherein producing the at least second image portion of the halftone image with the at least second halftone resolution includes producing a plurality of image portions of the halftone image with a plurality of halftone resolutions, and wherein varying the at least second halftone resolution of the at least second image portion from the halftone resolution of the first image portion includes varying the plurality of the halftone resolution of the plurality of image portions throughout the halftone image.

17. The method of claim 16, wherein varying the plurality of halftone resolutions throughout the halftone image includes scaling the plurality of halftone resolutions of the plurality of image portions throughout the halftone image.

18. The method of claim 16, wherein varying the plurality of halftone resolutions throughout the halftone image includes varying the plurality of halftone resolutions of the plurality of image portions from approximately 75 halftones-per-inch to approximately 600 halftones-per-inch throughout the halftone image.

19. The method of claim 16, wherein varying the plurality of halftone resolutions throughout the halftone image includes varying the plurality of halftone resolutions of the plurality of image portions at least one of vertically and horizontally.

20. A halftone image, comprising:
a first image portion having a first halftone resolution; and
at least a second image portion having at least a second halftone resolution, wherein the at least second halftone resolution of the at least second image portion varies from the first halftone resolution of the first image portion.

21. The halftone image of claim 20, wherein the at least second image portion includes a plurality of image portions with a plurality of halftone resolutions.

22. The halftone image of claim 21, wherein the plurality of halftone resolutions of the plurality of halftone image portions are scaled throughout the halftone image.

23. The halftone image of claim 21, wherein the plurality of halftone resolutions of the plurality of halftone image portions are varied from approximately 75 halftones-per-inch to approximately 600 halftones-per-inch throughout the halftone image.

24. The halftone image of claim 21, wherein the plurality of halftone resolutions of the plurality of image portions are varied at least one of vertically and horizontally throughout the halftone image.

25. A computer-readable medium having computer executable instructions for performing a method of identifying a scanned image, the method comprising:
creating an original image with a plurality of halftone resolutions;
scanning the original image at a scanning resolution to create the scanned image; and
generating a stamp in the scanned image when the scanning resolution is related to at least one of the plurality of halftone resolutions of the original image.

26. The computer-readable medium of claim 25, wherein creating the original image includes scaling the plurality of halftone resolutions of the original image throughout the original image.

27. The computer-readable medium of claim 25, wherein creating the original image includes varying the plurality of halftone resolutions of the original image from approximately 75 halftones-per-inch to approximately 600 halftones-per-inch throughout the original image.

28. The computer-readable medium of claim 25, wherein the scanning resolution is related to the at least one of the plurality of halftone resolutions of the original image when the scanning resolution matches the at least one of the plurality of halftone resolutions of the original image.

29. The computer-readable medium of claim 25, wherein generating the stamp in the scanned image includes distinguishing the scanned image from the original image.

30. The computer-readable medium of claim 25, wherein generating the stamp in the scanned image includes making the stamp visible in the scanned image.

31. The computer-readable medium of claim 25, wherein generating the stamp in the scanned image includes generating at least one of a word, symbol, character, mark, design, seal, pattern, distortion of the original image, and image artifact in the scanned image.

32. A computer-readable medium having computer executable instructions for performing a method of creating a halftone image, the method comprising:
producing a first image portion of the halftone image with a first halftone resolution; and
producing at least a second image portion of the halftone image with at least a second halftone resolution, including varying the at least second halftone resolution of the at least second image portion from the first halftone resolution of the first image portion.

33. The computer-readable medium of claim 32, wherein producing the at least second image portion of the halftone image with the at least second halftone resolution includes producing a plurality of image portions of the halftone image with a plurality of halftone resolutions, and wherein varying the at least second halftone resolution of the at least second image portion from the halftone resolution of the first image portion includes varying the plurality of the halftone resolution of the plurality of image portions throughout the halftone image.

34. The computer-readable medium of claim 33, wherein varying the plurality of halftone resolutions throughout the halftone image includes scaling the plurality of halftone resolutions of the plurality of image portions throughout the halftone image.

35. The computer-readable medium of claim 33, wherein varying the plurality of halftone resolutions throughout the halftone image includes varying the plurality of halftone resolutions of the plurality of image portions from approximately 75 halftones-per-inch to approximately 600 halftones-per-inch throughout the halftone image.

36. The computer-readable medium of claim 33, wherein varying the plurality of halftone resolutions throughout the halftone image includes varying the plurality of halftone resolutions of the plurality of image portions at least one of vertically and horizontally.
